(19) United States
(12) Patent Application Publication
(10) Pub. No.: US 2016/0193628 A1
(43) Pub. Date: Jul. 7, 2016

(54) JOINT SEAL

(71) Applicant: Airbus Operations GmbH, Hamburg (DE)

(72) Inventors: Johannes Maslennikov, Hamburg (DE); Sven Chromik, Hamburg (DE)

(73) Assignee: Airbus Operations GmbH, Hamburg (DE)

(21) Appl. No.: 14/982,880

(22) Filed: Dec. 29, 2015

(30) Foreign Application Priority Data
Jan. 2, 2015 (DE) 10 2015 100 002.4

(51) Int. Cl. B05D 1/02; B05B 3/00

(52) U.S. Cl. CPC B05D 1/02; B05B 3/00

(57) ABSTRACT

A device for sealing a joint includes a body having a bulging inner space, a first opening, in a first portion, from the outside into the inner space for introducing a sealing agent into the inner space, a second opening, at its second end, from the outside into the inner space, wherein the second opening and the inner space are designed such that the body can be positioned over a protruding part of a joint and the protruding part of the joint is completely surrounded by the body.

### FIELD OF THE INVENTION

The invention relates to a device and to a method for sealing a joint. In particular, the invention relates to a device and to a method for sealing a joint in a row of several joints.

### BACKGROUND OF THE INVENTION

Riveted or threaded joints are often used to connect components. In this case, part of the connecting bolt, for example a thread end onto which a nut is screwed or pressed, typically protrudes at least on one side. For supporting components, single or even double rows of joints can be provided in order to improve the transmission of forces from one component to the other.

Depending on the application, the components are sealed in the assembled state together with the connecting elements, e.g. against atmospheric influences. A sealing agent can be applied manually by means of a paintbrush. However, this is time-consuming and therefore expensive.

DE 10 2009 090 475 A1 describes a device, in which a kind of sponge, which is arranged in a cap, is saturated with a sealing agent, such as a paint. The shape and size of the cap is adapted to a protruding part of a threaded joint, and therefore the cap comprising the saturated sponge can be easily arranged over a protruding part of a threaded joint and can be wetted with the sealing agent by rotating the cap over the location of the threaded joint of the protruding part. As with a paintbrush, the quality is dependent here on the person carrying out the sealing.

Alternatively, a sealing agent can be sprayed in the form of an aerosol. Spraying using a spray gun, however, requires extensive safety measures for the person carrying out the spraying.

DE 10 2004 033 338, U.S. Pat. No. 2,488,195, WO 0 134 309, U.S. Pat. No. 2,270,579 and U.S. Pat. No. 6,074,135 each disclose spraying devices having a double-walled shield for the spray jet, air being extracted from the shield between the two walls of the shield so that, inter alia, harmful gases do not harm the person carrying out the spraying. The known spraying devices are provided for coating planar structures and have accordingly elongate spray heads and shields.

### BRIEF SUMMARY OF THE INVENTION

An aspect of the invention may provide a device and a method which can be used to efficiently seal complex structures having undercuts, for example a protruding part of a joint.

In general, a device for sealing a joint comprises a body having an inner space, the inner space having a first end, a first portion, a second portion, a second end and an axis and the inner space having a round cross section which is oriented transversely to the axis and has a diameter. In the first portion, the inner space has a diameter which increases in size along the axis from the first end towards the second end, and in the second portion has a diameter which decreases in size.

The body comprises at least two openings. A first opening from the outside into the inner space is provided in the first portion. A sealing agent can be introduced into the inner space through the first opening. A sprayable sealing agent can be sprayed into the inner space through the first opening, for example. A second opening from the outside into the inner space is provided at the second end. The second opening and the inner space are designed such that the body can be positioned over a protruding part of a joint and the protruding part of the joint is then completely surrounded by the body.

It is noted that an aspect of the invention is directed to sealing a complex protruding structure. A protruding part of a joint is a good example of such a structure. The device can of course also be used to seal other structures, even though the device according to the invention is described hereinafter in relation to being used on a joint.

According to one embodiment, in the first portion, the body of the device can have a third opening from the outside into the inner space. The third opening can be used for extracting air, gases and even surplus sealing agent from the inner space.

It is noted that the body can also comprise a plurality of first openings for introducing sealing agent. Alternatively or in addition, the body can comprise a plurality of third openings for extracting air, gases and sealing agent. The plurality of openings can be arranged evenly on the periphery of the body or inner space. Alternatively, the first openings and the third openings can be arranged such that an aerosol flow through the inner space of the body can be generated in a controlled manner.

The sprayable sealing agent can be introduced into the inner space in the form of a spray cone, wherein the spray cone can be defined by an axis and an opening angle. According to one embodiment, the axis of the spray cone can be inclined relative to the axis of the body. In this way, a larger proportion of the air/sealing agent mixture, i.e. of an aerosol, is introduced into the inner space on one side, as a result of which the aerosol flows through the inner space in a predetermined manner A flow of this kind can also be assisted by an adapted arrangement of one or more third holes.

According to one embodiment, the device further comprises a handle which is rotatably connected to the body. The body can preferably rotate about its axis relative to the handle. The handle can be designed in any manner from an ergonomic point of view. Furthermore, the device can be provided with an actuator, preferably on the handle, it being possible for both the introduction of the sealing agent into the inner space and the rotation of the body relative to the handle to be triggered by means of the actuator, in order to ensure a uniform seal over the entire periphery of the protruding connecting part.

According to one embodiment, the device comprises a connection for connecting the device to a sealing agent source. Furthermore, the device can have an additional connection for connecting to a vacuum pump, by means of which air, gases and/or sealing agent can be extracted from the inner space. In both cases, hoses are possible as connecting elements.

According to another aspect, a method for sealing a joint comprises the following steps. A device as described above is first provided. The device is arranged over a protruding part of a joint such that the protruding part of the joint is completely covered by the body. A sealing agent is then introduced into the inner space of the body and is applied to the protruding part of the joint. The body of the device can be rotated during the introduction and application of the sealing agent. Lastly, the device is removed from the joint.

According to one embodiment, the method can be carried out automatically in the form of a cycle, for example the device can introduce sealing agent into the inner space for a predetermined amount of time and/or can rotate the body by a predetermined amount, for example by 360°. At the end of a cycle, the device can provide a signal such as an acoustic or light signal.

The above-described aspects and further aspects, features and advantages of the invention can also be seen in the examples of the embodiments which are described in the following with reference to the accompanying drawings.

### BRIEF DESCRIPTION OF THE DRAWINGS

FIG. 1 is a sectional view of a device according to a first embodiment.

FIG. 2 is a sectional view of a device according to a second embodiment.

FIG. 3 is a sectional view of a device according to a third embodiment.

FIG. 4 is a sectional view of a device according to a fourth embodiment.

FIG. 5 is a flow diagram illustrating a method.

In the figures, the same reference numerals are used for identical or at least similar elements, components or aspects. It is noted that embodiments which are merely illustrative and non-restrictive are described in detail in the following.

### DETAILED DESCRIPTION

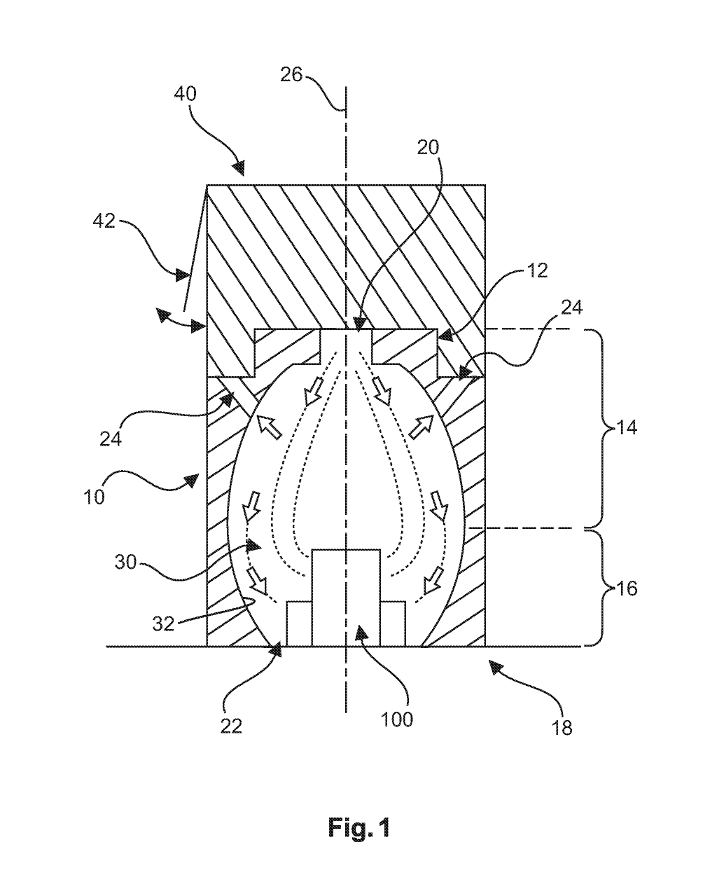

FIG. 1 shows a device for sealing a joint according to a first embodiment. The device comprises a body 10 having an inner space 30 and a handle 40. The body 10 comprises a first end 12 and a second end 18, a first portion 14 and a second portion 16 being definable between said two ends. The boundary between the first and the second portion is determined by the point where the diameter of the inner space 30 is at its largest.

The second end 18 of the body 10 comprises an opening 22 which is dimensioned such that a protruding part 100 of a joint can pass through the opening 22. The body comprises a first opening 20 at the first end 12. A sealing agent can be introduced into the inner space 30 through the opening 20.

The inner space 30 can be bulging. This means that the diameter of the round inner space is smaller at the first end 12 and at the second end 18 thereof than in a central region between the first and the second end. The inner space can also be substantially drop-shaped, it being possible for the distance between the region having the largest diameter and the second end 18 to be smaller than the distance between the region having the largest diameter and the first end 12.

With the aim of deflecting an aerosol flow, the contour line preferably has no bends or breaks. The contour line can be a continuously curved line, it being possible for the curvature to have just one radius of curvature or even a plurality of radii of curvature.

In FIG. 1, the sealing agent is a sprayable agent. The arrows in the inner space 30 of the body 10 indicate how the sealing agent is distributed inside the inner space when it is sprayed by means of a spray cone, the axis of which is parallel to the axis 26 of the body 10. Aerosol particles flow uniformly from the opening 20 outwards and are deflected towards the centre by the curvature of the wall 32 of the inner space in the lower part of the inner space. In this way, the aerosol particles can reach the protruding part 100 not only from above, but also from the side, thereby also reliably covering undercuts on the protruding part 100 with sealing agent.

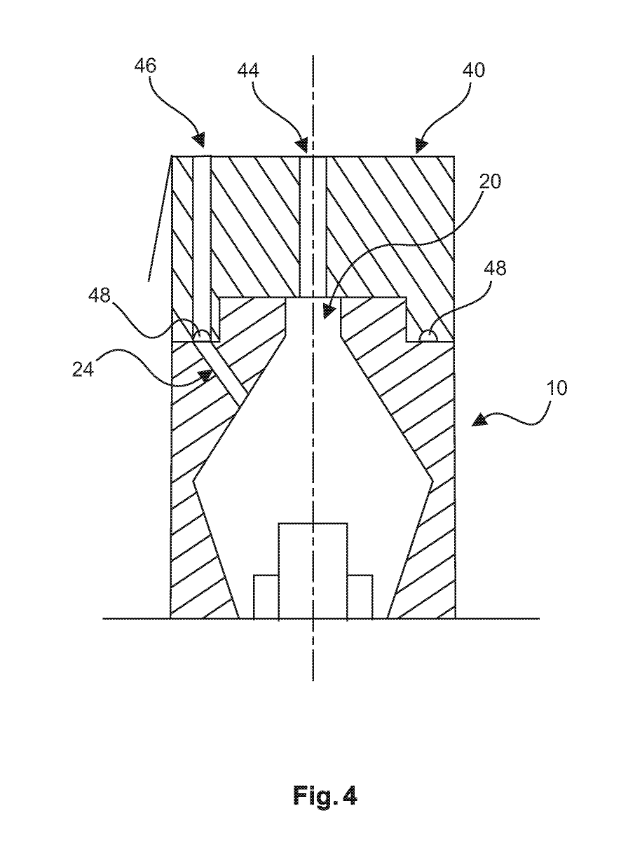

Most of the aerosol particles accelerated during spraying settle on the protruding part 100 due to the particle flow. The rest can be extracted through the openings 24 together with air and gas. The openings 20 and 24 open out into channels which are provided in the handle 40 and lead to connections for supplying sealing agent and for extraction. Channels of this type are not shown in the schematic view in FIG. 1. Example channels are shown in FIG. 4.

An actuator 42 is provided on the handle 40 and can be operated when the device is held by hand by the handle. Operating the actuator 42 can trigger spraying of sealing agent on one hand and extraction on the other hand. Spraying can be controlled as a sequence of short spray puffs or even as a continuous flow, it being possible for said control to be carried out either manually or automatically when the device is set up accordingly.

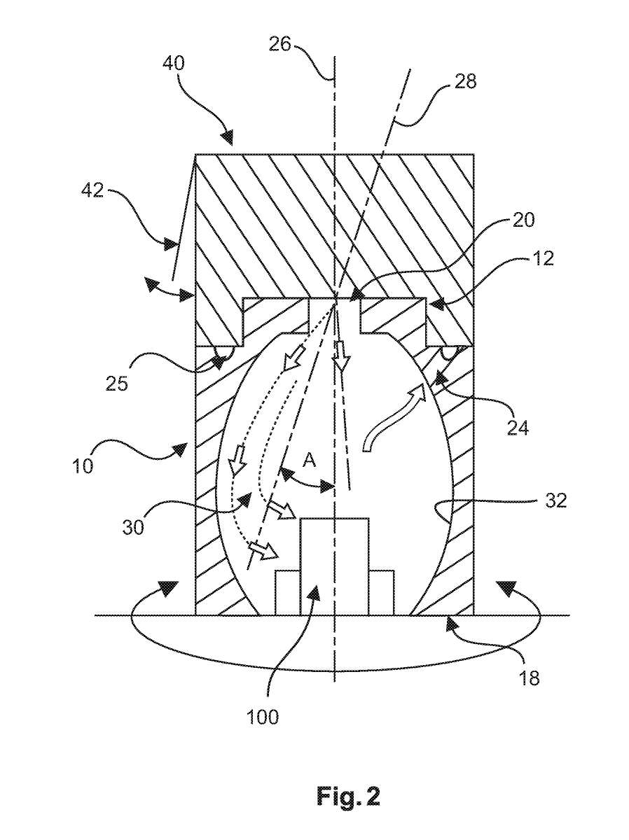

FIG. 2 shows a second embodiment of a device having a body 10 and a handle 40. According to this embodiment, a spray cone of a sealing agent is sprayed at an angle into the inner space 30 of the body 10. The axis 28 of the spray cone is correspondingly inclined relative to the axis 26 of the body 10. In order to achieve spraying of this kind, the first opening 20 is configured accordingly.

As indicated by the arrows in the inner space 30, oblique spraying generates an aerosol flow which flows more intensely on one side of the inner space from the first end 12 to the second end 18, the aerosol flow also being deflected in this case in the lower part by the curved wall 32 of the inner space so that the protruding part 100 can also be sealed from the side.

The flow through the inner space can be assisted by extraction on the side of the inner space remote from the spray cone. This is indicated in FIG. 2 by the arrow which points to one of the openings 24.

In order to completely seal the protruding part 100 of a joint, i.e. to seal all sides, according to the embodiment in FIG. 2 at least the body 10 can be rotated about its axis 26. This means that the device, including the body 10 and the handle 40, can be rotated about the axis 26 or even just the body 10 can be rotated relative to a stationary, i.e. non-rotating, handle 40. For this purpose, a link can be formed between the body 10 and the handle 40. The rotation can be brought about either manually or by an electric, electromagnetic, hydraulic or pneumatic drive or any other drive. For example, an air pressure which is used during spraying and extraction, could also be used to drive the rotation.

As in FIG. 1, a channel in the handle is not visible in FIG. 2. However, it is noted that a circumferential groove 25 should be provided in either the body or the handle in order to ensure continuous extraction when the body rotates relative to the handle. In the arrangement shown in FIG. 2, a channel could be provided in the handle either in front of or behind the sectional plane.

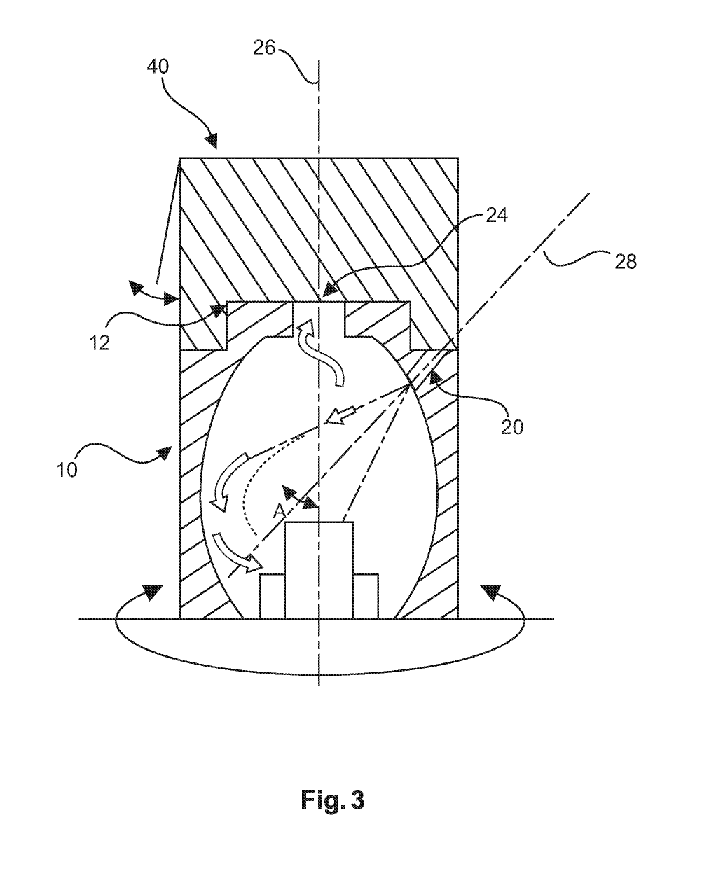

FIG. 3 shows a variant of the embodiment in FIG. 2. The embodiments differ in that the function of the openings 20 and 24 is reversed. In FIG. 3, extraction is carried out through the central opening 24 at the first end 12 of the body 10 and sprayable sealing agent is sprayed into the inner space through an opening 20 arranged somewhat to the side. An arrangement of this type allows for a larger angle A between the axis 28 of the spray cone and the axis 26 of the body 10.

In the embodiment in FIG. 3, too, at least the body 10 can be rotated about its axis 26 in order to seal the joint from all sides. Here too the curved inner wall of the body causes the aerosol flow to be deflected.

The actuator 42 can trigger the introduction of sealing agent into the inner space, as well as extraction and also rotation of the body.

FIG. 4 shows a fourth embodiment of a device for sealing a joint. This embodiment differs from the other embodiments first and foremost in that the contour of the inner space has a bend, and in that the contour line is formed by straight portions.

As shown in FIG. 4 by way of example, the openings 20 and 24 can be connected to channels 44 and 46 in the handle 40. An annular groove 48 can be provided between the opening 24 and the channel 26 and is open towards the body so that a connection is always ensured between the opening 24 and the channel 46 even when the body rotates relative to the handle. It is noted that the channels can also be formed towards the side of the handle so that the connection for the sealing agent supply and/or the connection for the extraction can be provided at the side instead of at the top.

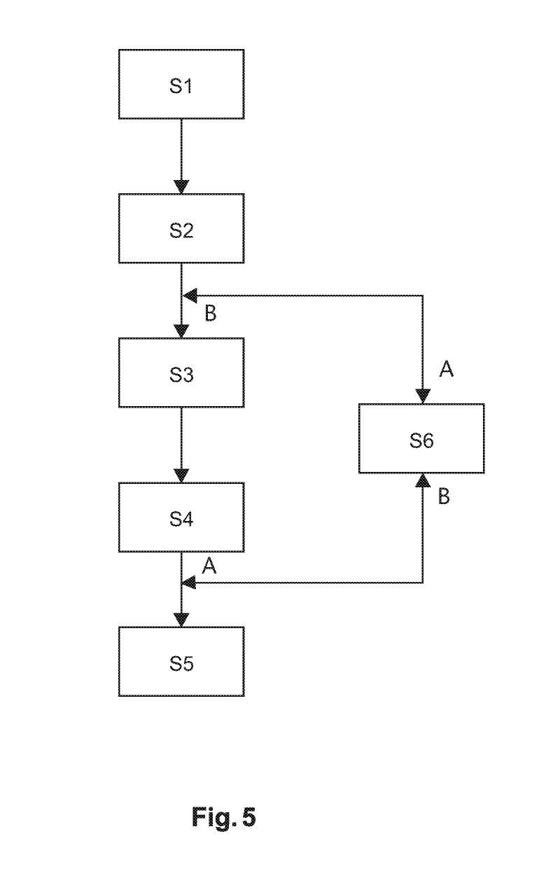

FIG. 5 is a flow diagram showing the principle steps of a method for sealing a joint. It is noted that the steps described are main steps which can be differentiated and divided into sub-steps. Furthermore, additional sub-steps can be provided between the main steps. A sub-step is only mentioned if said step is crucial for the understanding of the principle of the method.

In step S1, a device as described above is provided. The device is connected at least to a sealing agent reservoir. Depending on the embodiment, the device can also be connected to a vacuum pump. Furthermore, it is possible for the device to be connected to a power source, for example if the rotation of the body relative to the handle is electrically driven.

In step S2, the device is arranged over a joint to be sealed so that a protruding part of the joint is completely covered by the body.

In step S3, a sealing agent is introduced, preferably injected or sprayed, into the inner space of the body.

In step S4, the surface of the protruding part of the joint is wetted with sealing agent, i.e. the sealing agent is applied to the protruding part of the joint, thereby sealing the joint.

Step S6, which is arranged at the side of the flow diagram, denotes that the body of the device is rotated relative to the handle. The arrows A denote a variant, in which the rotation can happen in parallel, i.e. simultaneously with, the introduction of the sealing agent into the inner space of the body and the application to the protruding part, whereas the arrows B indicate that the rotation can alternate with the introduction and application. For example, the body could be rotated by a few degrees following a short spray puff into the inner space, which is then again followed by a spray puff, etc.

In step S5, the sealing is completed and the device is removed from the joint.

While the invention has been illustrated and described in detail in the drawings and the above description, illustrations and descriptions of this type are intended to be merely illustrative or exemplary and not restrictive, and therefore the invention is not limited by the embodiments disclosed. In the claims, the word “comprising” does not exclude other elements and the indefinite article “a” or “an” does not exclude a plurality.

The mere fact that particular features are specified in different dependent claims does not limit the subject matter of the invention. Combinations of these features may also be used advantageously. The reference numerals in the claims are not intended to restrict the scope of the claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or ” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE NUMERALS

10 body
12 first end
14 first portion
16 second portion
18 second end
20 first opening
22 second opening
24 third opening
25 circumferential groove
26 body axis
28 spray cone axis
30 inner space
32 wall
40 handle
42 actuator
44, 46 channels
48 circumferential groove
100 joint

1. A device for sealing a joint, the device comprising:
a body having an inner space having a first end, a first portion, a second portion, a second end and an axis,
wherein the inner space has a round cross section oriented transversely to the axis and has a diameter,
wherein, in the first portion, the inner space has a diameter increasing in size along the axis from the first end towards the second end, and in the second portion, the inner space has a diameter decreasing in size,
wherein, in the first portion, the body has a first opening from the outside into the inner space, the first opening is configured for introducing a sealing agent into the inner space, and
wherein, at the second end, the body comprises a second opening from the outside into the inner space, wherein the second opening and the inner space are configured such that the body is positionable over a protruding part of a joint and the protruding part of the joint is completely surrounded by the body.

2. The device according to claim 1, wherein the first opening is configured for introducing a sprayable sealing agent into the first portion of the inner space.

3. The device according to claim 2, wherein the body comprises a third opening from the outside into the inner space, the third opening being arranged in the first portion and configured for extracting sealing agent from the first portion of the inner space.

4. The device according to claim 3, wherein the body comprises a plurality of first openings and/or a plurality of third openings.

5. The device according to claim 2, wherein the first opening is configured for introducing the sealing agent into the inner space in the form of a spray cone.

6. The device according to claim 5, wherein the spray cone has a central axis, wherein the first opening is configured such that the central axis of the spray cone is inclined relative to the axis of the body.

7. The device according to claim 1, further comprising a handle connected to the body such that the body is rotatable about the axis thereof relative to the handle.

8. The device according to claim 7, further comprising an actuator configured to trigger at least one of the introduction of the sealing agent into the inner space and/or the rotation of the body relative to the handle.

9. A method for sealing a joint, the method comprising:
providing a device according to claim 1;
arranging the device such that a protruding part of the joint is completely covered by the body;
introducing a sealing agent into the inner space of the body;
applying the sealing agent to the protruding part of the joint; and
removing the device from the joint.

10. The method according to claim 9, the method further comprising rotating the body of the device relative to the handle while the sealing agent is introduced into the inner space of the body.
